(19) United States
(12) Patent Application Publication
(10) Pub. No.: US 2022/0397102 A1
(43) Pub. Date: Dec. 15, 2022

(54) New Renewable Clean Energy Acquiring Method and System

(71) Applicant: Weiping Meng, Flushing, NY (US)

(72) Inventor: Weiping Meng, Flushing, NY (US)

(21) Appl. No.: 17/776,214

(22) PCT Filed: Nov. 12, 2019
(86) PCT No.: PCT/CN2019/000215

§ 371 Date: May 11, 2022

(51) Int. Cl. F03G 5/02; A63B 22/02

(52) U.S. Cl. CPC F03G 5/025; A63B 22/0242

(57) ABSTRACT

The invention relates to renewable clean energy field, discloses a fitness exercise energy acquiring method and system, the method includes steps: (1) user signs up and sign in the system; (2) the system acquires fitness exercise energy and its users related information; (3) the system alters acquired energy into usable energy form; (4) the acquired energy is used; (5) user benefit from the system settlement; the system comprises components: (1) fitness exercise energy information acquiring subsystem; (2) fitness exercise energy information server and communication network system; (3) fitness exercise energy acquiring device; (4) fitness exercise energy usable electrical current alteration subsystem; (5) fitness exercise energy output control subsystem. The present invention realize change of energy released during daily fitness exercise into usable energy, both do fitness exercise and generate clean energy, fitness exercises of human and animals will generate more than one hundred millions kWh per day, with reference to present fitness equipment, obtain energy conservation and environmental protection timeliness of fitness exercises.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates to new renewable clean energy, particularly to a method and system acquiring an usually ignored daily energy.

People strive to seek and develop various new energy, such as solar power, wind power, sea wave power, biochemical energy, in order to decrease and substitute current resource-consuming-dependent and polluting energy. There is a kind of clean energy ignored with contemporary people life, that is the energy consumed during hundreds of millions of people's daily various fitness exercise and may be used to generate electric power just like small wind power generators.

### BRIEF SUMMARY OF THE INVENTION

It is an object of the present invention to realize new clean generating system based on people's daily various fitness exercises.

The present invention proposes fitness exercise energy acquiring method and system achieving the above object.

A fitness exercise energy acquiring method includes steps:

S1, Install fitness exercise (FE) energy acquiring system (FEE AS), no needing to install user-manager and internet for independent self-service system;

S2, User creates his/her FEE AS account, excluding independent self-service system;

S3, User signs in FEE AS when using FEE AS, excluding independent self-service system;

S4, FEE AS acquires users' FE energy and their related information when used by the users;

S5, FEE AS alters acquired FEE into usable energy form by electric current conversion;

S6, The FEE is used by the users directly, charged into battery, or output onto grid connected;

S7, The user benefits from FEE AS settlement, excluding independent self-service system;

Said fitness exercise energy (FE energy or FEE) means energy released during fitness exercise of a living body, wherein FE means motion of a living body for health;

Said fitness exercise energy acquiring system (FEE AS) includes fitness exercise energy acquiring device (FEE AD), users' FEE information management software, FEE grid connecting function, or/and FEE promoting financial service system; through the users' FEE information management software, users register, sign in first when using, then FEE information are recorded and saved, sent into grid system connected, meanwhile, FEE may also be sent onto grid connected;

Said fitness exercise energy acquiring device (FEE AD) means any mechanical structure form of fitness exercise apparatus that can convert kinetic energy;

Said independent self-service system means FEE AS non-grid connected without needing identified users;

Said user means people, groups of people if they are in a group, who use the above FEE AD, directly or indirectly, wherein “indirectly” means FEE AD users without identifying individual identity;

Said fitness exercise energy information (FEE Info) means user's personal information and physical state data, quantitative FE energy acquired;

Said benefit from FEE AS settlement means that user directly or indirectly obtains economic benefits through their releasing FEE.

Another feature of the fitness exercise energy acquiring method includes: S1, Said fitness exercise energy acquiring system (FEE AS) includes fitness exercise energy acquiring device (FEE AD), users' FEE information management software, FEE grid connecting function, or/and FEE promoting financial service system; through the users' FEE information management software, users register, sign in first when using, then FEE information are recorded and saved, sent into grid system connected, meanwhile, FEE may also be sent onto grid connected.

Another feature of the fitness exercise energy acquiring method includes: S4, FEE AS acquires users' FE energy and their related information when used by the users.

Another feature of the fitness exercise energy acquiring method includes: S41, type of acquiring FEE is electrical energy, way of acquiring FEE is determined on principle and mechanical structure of equipment used to acquire FEE, the principle means any principle generating electricity, mechanical energy to electromagnetic energy, pressure to electricity, frictional electricity, the mechanical structure means any sports equipment with FEE-acquirable equipment installed, such as running machine, bicycle:

Another feature of the fitness exercise energy acquiring method includes:
S42, the acquired FEE Info includes identity and group of user acquired through registration, scanning code recognition, face recognition, fingerprint identification; health status of user acquired through health monitoring equipment, quantified FE energy of user acquired through FEE-related sensors in FEE system; also management unit, contact, heart pulse rate, blood pressure, body weight, accumulated FEE acquired;

Another feature of the fitness exercise energy acquiring method includes:
S43, save FEE Info in local database system.

Another feature of the fitness exercise energy acquiring method includes:
S44, send FEE info confirmed by grid to database of grid.

Another feature of the fitness exercise energy acquiring method includes;
S45, send FEE info to user's mobile phone.

Another feature of the fitness exercise energy acquiring method includes;
S6, FE energy is used by the users directly, charged into battery, or output onto grid connected.

Another feature of the fitness exercise energy acquiring method includes;
S7, the user benefits from FEE AS settlement, means user directly or indirectly economic benefits through their releasing FEE: including directly in cash converted according to FE energy acquired from user and electricity price, or, and indirectly in other ways of benefits, lower thresholds or provide more services and time of medical insurance, life insurance

A fitness exercise energy acquiring system includes:

(1), Fitness exercise (FE) energy information acquiring subsystem, excluding independent self-service FEE system;

(2), Fitness exercise (FE) energy information server and network communication subsystem, excluding independent self-service FEE system;

(3), Fitness exercise (FE) energy acquiring device;

(4), FE energy-usable electrical current form alteration subsystem;

(5), FE energy output control subsystem, directly used, charged, or output to grid connected;

(6), User benefit from FEE AS settlement software module, excluding independent self-service system;

Said FE energy information acquiring subsystem includes a computer system with signing-up, signing-in, saving FEE info, personal identity identifying device, heart rate monitor, blood pressure monitoring device, FEE measuring and recording device;

Said FE energy information server means a computer that runs software and database for users' sign-up, sign-in, save FEE info, and, software for User benefit from FEE AS settlement;

Said FE energy acquiring device includes FE motion acquisition and transmission unit, acceleration and transmission components, power generating components, any mechanical structure form that changes mechanical motion into electricity, as FE assistant device;

Said FE energy-usable electrical current form alteration subsystem includes rectifier, inverter, or frequency converter, or and their combinations;

Said FE energy output control subsystem includes open circuit switching controller and control information sensing networks;

Another feature of the fitness exercise energy acquiring system includes:

(1), Said FE energy information acquiring subsystem includes a computer system with signing-up, signing-in, saving FEE info, personal identity identifying device, heart rate monitor, blood pressure monitoring device, FEE measuring and recording device, excluding independent self-service system;

Another feature of the fitness exercise energy acquiring system includes:

(3), Said FE energy acquiring device means any mechanical structure form that changes mechanical motion into electricity, as FE assistant device;

Another feature of the fitness exercise energy acquiring system includes

(5), Said FE energy output control subsystem includes open circuit switching controller and control information sensing networks, watt-hour meter, user output and input wires, user's electrical appliances wires and sockets;

The advantages of the present invention are below: realize acquisition of electric energy from fitness exercise, change fitness exercise time into power generation time, turn energy released during daily fitness exercise into usable energy, both do fitness exercise and generate clean energy, fitness exercises of human and animals will generate more than one hundred millions kWh per day, with reference to present fitness equipment, obtain energy conservation and environmental protection timeliness of fitness exercises.

### BRIEF DESCRIPTION OF THE DRAWINGS

FIG. 1 is a flowchart of fitness exercise energy acquiring method;

FIG. 2 is fitness exercise energy acquiring system—treadmill fitness exercise energy system;

FIG. 3 shows basic tables of fitness exercise energy information database;

FIG. 4 is a flowchart of FE energy acquiring user direct benefit from FEE AS settlement;

FIG. 5 is an embodiment of user direct benefit monthly table from FEE AS settlement;

### LIST OF REFERENCE NUMERAL UTILIZED IN THE DRAWING

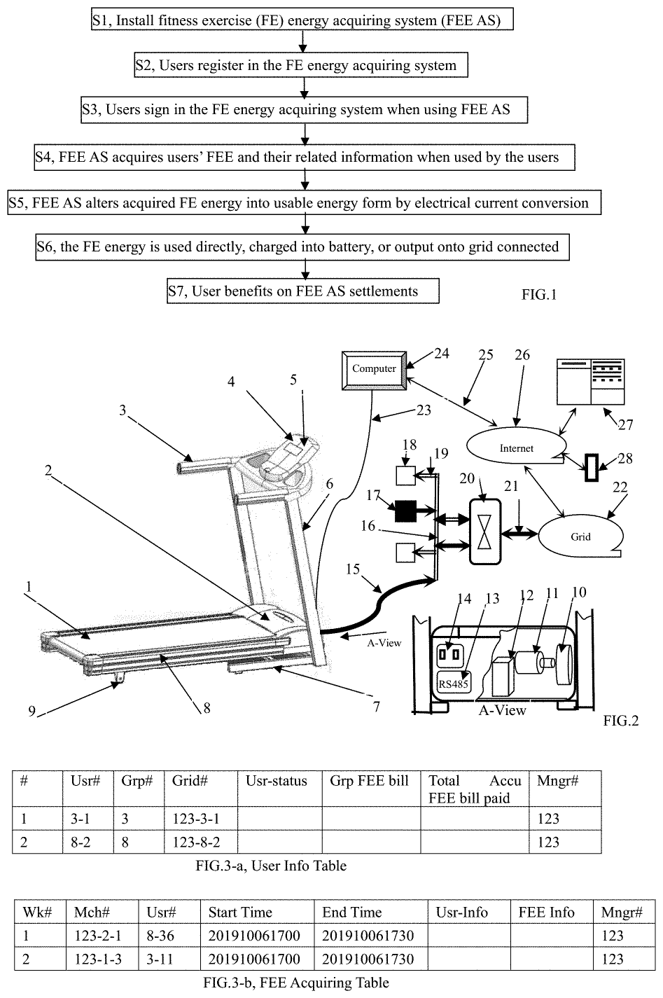

FIG. 2: 2-1—FE motion acquisition and transmission unit—moving belt and its roller; 2-2— energy generation box; 2-3—handrail; 2-4—FE user physical state display; 2-5—FE energy display; 2-6—trestle; 2-7—chassis; 2-8—moving belt guide rail; 2-9—supporting wheel; 2-10— acceleration and transmission components; 2-11—electric generator; 2-12—current converter components; 2-13—data lines sockets; 2-14— socket of power output to grid connected; 2-15—power output line; 2-16—Indoor power distribution lines; 2-17—other FEE acquisition devices or/and battery; 2-18—electric appliances as load; 2-19—wires; 2-20—open circuit switching controller, also including energy switching router, watt-hour meter, etc.; 21—household distribution line; 2-22—grid; 2-23—local communication networks, wireless or/and wire hybrid networks, wifi or mobile phone communication network; 2-24—user control terminal; 2-25— communication network access line; 2-26—communication network access, wireless or/and wire hybrid networks, wifi or mobile phone communication network, internet; 2-27—main grid distribution center, information server and database, cloud service center; 2-28—user mobile phone; in addition, a sensors network of FEE AS not labeled that connects sensors acquiring FEE AS parameters, including user pace rate, primary rotation speed, motor rotation speed, electric energy parameters, protection parameters, switching open circuit control status parameters, etc;

### DETAILED DESCRIPTION OF THE INVENTION

### Description of the Preferred Embodiments, Industry Applications

A detailed description of embodiment of the invention in conjunction with the accompanying drawings:

Create fitness exercise energy gym in high building where there are many companies, according to fitness exercise (FE) energy acquiring method, including steps as FIG. 1;

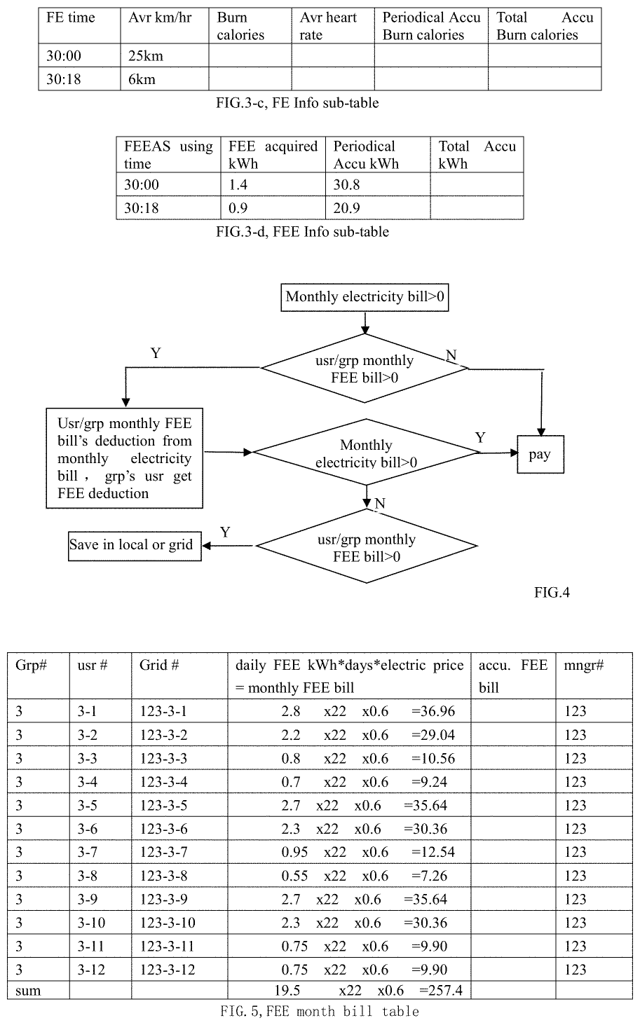

S1, Install fitness exercise (FE) energy acquiring system (FEE AS) managing many FE energy acquiring devices, connecting to grid, including;
(1), FE energy information acquiring subsystem, including a computer system with signing-up, signing-in, saving FEE info, personal identity identifying device, heart rate monitor, blood pressure monitoring device, FEE measuring and recording device;
(2), FE energy information server and communication network 2-24, 2-25, 2-26, mean a computer that runs software and database for users' sign-up, sign-in, save FEE info, and, software for User benefit from FEE AS settlement; basic tables of database as FIG. 3;
(3), Fitness exercise (FE) energy acquiring device 2-1,2-2, including moving belt 2-1 and its driving roller of 100 mm diameter of FE motion acquisition and transmission unit, acceleration and transmission components 2-10 designed two cascaded three times speed increasing speed mechanisms gaining 6 times speed increase, power generating components 2-11 using 2 kW to 3 kW wind power electric generator whose work rotation speed is high to 3000 rpm, and running machine as their combinations form as FE assistant device; when using FEE bicycle as their combinations form, use 10 kW wind power electric generator as power generating components and roller chain as FE motion acquisition and transmission unit, three times speed increasing speed mechanisms as acceleration and transmission components;

(4), FE energy-usable electrical current form alteration subsystem 2-12 is designed as grid-connectable rectifier, inverter of small wind power generator;

(5), FE energy output control subsystem 2-20 is designed as multi FE energy devices directly used, output to grid connected, controlled through open circuit switching controller and control information sensing networks, double watt-hour meters that record output/input energy, household distribution line 2-21, indoor power distribution lines and sockets;

S2, User creates his/her FEE AS account by sign-up, with his/her personal identification, mobile phone number, certificate and contact of an unit where the user works, then is entered in users table after checked and permitted;

S3, User signs in FEE AS when using FEE AS, by scanning personal ID to confirm the FEE AS user;

S4, FEE AS acquires users' FE energy and their related information when FEE acquiring device and FEE AS are used by the users: user do fitness exercise on moving belt 2-1 in speed 1 meter to 2 meters per second releasing revolution energy onto the 100 mm diameter roller with revolution speed in 3 to 6 revolutions per second, that is transmitted to FEE energy generation box 2-2, where acceleration and transmission components 2-10 the revolution speed is increased 6 times to 18 to 36 revolutions per second, 1080 to 2160 revolutions per minute, then by electromagnetic structure, electric generator 2-11 generates electricity; through rectifier and inverter of current converter components 2-12, the electricity is altered in the form of standard voltage 220v and phase that is capable of output to grid, output on socket 2-14 through wire 2-15 to open circuit switching controller 2-20, that is controlling the connection switch between household distribution line 2-21 and grid 2-22; double watt-hour meters in open circuit switching controller 2-20 record input/output data of electrical energy; meanwhile, the FEE information data is sent to database of user control terminal 2-24 by data bus 2-13 and local network 2-23, further sent to information server and database of main grid distribution center 2-27 by communication network 2-25 and 2-26; user body state in sport, sport speed and heart rate, electric energy generated, voltage, current of the FEE information are recorded in user control terminal database, as tables 3-a,3-b,3-c,3-d, which are displayed in screens 2-4,2-5;??

S5, FEE AS alters acquired FEE into usable energy form by electric current conversion: irregular current generated by electrical generator 2-11, through rectifier in current converter components 2-12, is rectified into direct current, then inverted into grid-connectable form of standard voltage and phase by inverter in 2-12;

S6, The FEE is used by the users directly, charged into battery, or output onto grid connected: FEE voltage and current monitored real time through FEE formation sensing networks and controlled through FEE open circuit switching controller 2-20, and switched power to indoor appliances 2-18 through indoor power distribution lines 2-16, that's, when FE energy is available, switch off power of grid 2-21,2-22, input watt-hour meter of grid stops work, and switch on power of FE energy 2-14,2-15, or 2-17, output watt-hour meter of grid starts work; when FE energy is not available, switch on power of grid, input watt-hour meter of grid starts work, and switch off power of FE energy, output watt-hour meter of grid stops work; or/and charge battery 2-17;

S7, User benefit from FEE AS settlement, according to bill data as in FIG. 5 and directly benefit method from FEE AS settlement as FIG. 4, present period (month) electricity bill of group 3 (grp3 in FIG. 5, a company) is ¥320, including 22 office days of the month, all users (user in FIG. 5) of the group (12 persons of group 3 sign up in the FEE AS), every user of the group has done FEE sport in FEE AS for 30 minutes every day following the group's regulations; wherein treadmill used of FEE acquiring device generates almost 1 kWh of electricity for each time of the using, bicycle used generates more than 1 kWh of electricity for each time of the using, electricity price is ¥0.6 per kWh, the month bill of FEE acquired of the group is ¥257.40, the company balance after deduction of FEE month bill from its month electricity bill is ¥62.60 (present month electricity bill ¥320−¥257.40), the company may reward some cash to each user of the FEE AS in the group, increase the users' medical insurance time and service for users who use FEE AS 3 months, the company receives some rewards from energy conservation and environmental protection department and public health commission.

What is claimed as new and desired to be protected by Letters Patent is set forth in the following:

1. A fitness exercise energy acquiring method includes steps:
S1, Install fitness exercise (FE) energy acquiring system (FEE AS), no needing to install user-manager and internet for independent self-service system;
S2, User creates his/her FEE AS account, excluding independent self-service system;
S3, User signs in FEE AS when using FEE AS, excluding independent self-service system;
S4, FEE AS acquires users' FE energy and their related information when used by the users;
S5, FEE AS alters acquired FEE into usable energy form by electric current conversion;
S6, The FEE is used by the users directly, charged into battery, or output onto grid connected;
S7, The user benefits from FEE AS settlement, excluding independent self-service system;
Said fitness exercise energy (FE energy or FEE) means energy released during fitness exercise of a living body, wherein FE means motion of a living body for health;
Said fitness exercise energy acquiring system (FEE AS) includes fitness exercise energy acquiring device (FEE AD), users' FEE information management software, FEE grid connecting function, or/and FEE promoting financial service system; through the users' FEE information management software, users register, sign in first when using, then FEE information are recorded and saved, sent into grid system connected, meanwhile, FEE may also be sent onto grid connected;
Said fitness exercise energy acquiring device (FEE AD) means any mechanical structure form of fitness exercise apparatus that can convert kinetic energy;
Said independent self-service system means FEE AS non-grid connected without needing identified users;
Said user means people, groups of people if they are in a group, who use the above FEE AD, directly or indirectly, wherein “indirectly” means FEE AD users without identifying individual identity;
Said fitness exercise energy information (FEE Info) means user's personal information and physical state data, quantitative FE energy acquired;
Said benefit from FEE AS settlement means that user directly or indirectly obtains economic benefits through their releasing FEE.

2. A fitness exercise energy acquiring method as in claim 1, wherein S1, Said fitness exercise energy acquiring system (FEE AS) includes fitness exercise energy acquiring device (FEE AD), users' FEE information management software, FEE grid connecting function, or/and FEE promoting financial service system; through the users' FEE information management software, users register, sign in first when using, then FEE information are recorded and saved, sent into grid system connected, meanwhile, FEE may also be sent onto grid connected.

3. A fitness exercise energy acquiring method as in claim 1, wherein S4, FEE AS acquires users' FE energy and their related information when used by the users.

4. A fitness exercise energy acquiring method as in claim 3, wherein step S4 includes: S41, type of acquiring FEE is electrical energy, way of acquiring FEE is determined on principle and mechanical structure of equipment used to acquire FEE, the principle means any principle generating electricity, mechanical energy to electromagnetic energy, pressure to electricity, frictional electricity, the mechanical structure means any sports equipment with FEE-acquirable equipment installed, such as running machine, bicycle.

5. A fitness exercise energy acquiring method as in claim 1, wherein step S4 includes: S42, the acquired FEE Info includes identity and group of user acquired through registration, scanning code recognition, face recognition, fingerprint identification; health status of user acquired through health monitoring equipment, quantified FE energy of user acquired through FEE-related sensors in FEE system; also management unit, contact, heart pulse rate, blood pressure, body weight, accumulated FEE acquired.

6. A fitness exercise energy acquiring method as in claim 3, wherein step S4 includes: S43, save FEE Info in local database system.

7. A fitness exercise energy acquiring method as in claim 3, wherein step S4 includes: S44, send FEE info confirmed by grid to database of grid.

8. A fitness exercise energy acquiring method as in claim 3, wherein step S4 includes: S45, send FEE info to user's mobile phone.

9. A fitness exercise energy acquiring method as in claim 1, wherein includes: S6, multi FE energy are used by the users directly, charged into battery, or selected by FE energy router and output onto grid connected.

10. A fitness exercise energy acquiring method as in claim 1, wherein includes: S7, the user benefits from FEE AS settlement, means user directly or indirectly economic benefits through their releasing FEE: including directly in cash converted according to FE energy acquired from user and electricity price, or, and indirectly in other ways of benefits, lower thresholds or provide more services and time of medical insurance, life insurance.

11. A fitness exercise energy acquiring system, wherein includes:
(1), Fitness exercise (FE) energy information acquiring subsystem, excluding independent self-service FEE system;
(2), Fitness exercise (FE) energy information server and network communication subsystem, excluding independent self-service FEE system;
(3), Fitness exercise (FE) energy acquiring device;
(4), FE energy-usable electrical current form alteration subsystem;
(5), FE energy output control subsystem, directly used, charged, or output to grid connected;
(6), User benefit from FEE AS settlement software module, excluding independent self-service system;
Said FE energy information acquiring subsystem includes a computer system with signing-up, signing-in, saving FEE info, personal identity identifying device, heart rate monitor, blood pressure monitoring device, FEE measuring and recording device;
Said FE energy information server means a computer that runs software and database for users' sign-up, sign-in, save FEE info, and, software for User benefit from FEE AS settlement;
Said FE energy acquiring device includes FE motion acquisition and transmission unit, acceleration and transmission components, power generating components, any mechanical structure form that changes mechanical motion into electricity, as FE assistant device;
Said FE energy-usable electrical current form alteration subsystem includes rectifier, inverter, or frequency converter, or and their combinations;
Said FE energy output control subsystem includes open circuit switching controller and control information sensing networks.

12. A fitness exercise energy acquiring system, as in claim 11, wherein step S1 includes: (1), Said FE energy information acquiring subsystem includes a computer system with signing-up, signing-in, saving FEE info, personal identity identifying device, heart rate monitor, blood pressure monitoring device, FEE measuring and recording device, excluding independent self-service system.

13. A fitness exercise energy acquiring system, as in claim 11, wherein includes: (3), Said FE energy acquiring device means any mechanical structure form that changes mechanical motion into electricity, as FE assistant device.

14. A fitness exercise energy acquiring system, as in claim 11, wherein step 4 includes: (4), Said FE energy-usable electrical current form alteration subsystem includes rectifier, inverter, or frequency converter, or and their combinations.

15. A fitness exercise energy acquiring system, as in claim 11, wherein (5) Said FE energy output control subsystem controls multi-FE exercise energy devices.
